(19) United States
(12) Patent Application Publication
(10) Pub. No.: US 2004/0234006 A1
(43) Pub. Date: Nov. 25, 2004

(54) Reducing peak-to-average signal power ratio

(76) Inventor: Stephen Y Leung, Pine Brook, NJ (US)

Correspondence Address: MENDELSOHN AND ASSOCIATES PC, 1515 MARKET STREET, SUITE 715, PHILADELPHIA, PA, 19102, US

(21) Appl. No.: 10/476,294

(22) PCT Filed: Feb. 27, 2003
(86) PCT No.: PCT/US03/05934

(30) Foreign Application Priority Data
Mar. 1, 2002 (US) 60360855
Mar. 8, 2002 (US) 60362651

(51) Int. Cl. H04L 27/06

(52) U.S. Cl. 375/316

(57) ABSTRACT

A copy of an input signal is clipped and subtracted from another copy of the input signal to generate an error signal corresponding to the clipped portion of the inpur signal. The error signal is filtered to generate a signal that is subtracted from another copy of the input signal to generate a filtered, clipped version of the input signal having a reduced peak-to-average power ratio. The frequency characteristics of the filtering match those of the input signal. For example, when the input signal has distinct frequency bands, the filtering preferably corresponds to a combination of band-pass filters, each corresponding to a different input frequency band. Because only the error signal and not the input signal itself is filtered, the resulting output signal can have a relatively low peak-to-average power ratio, while retaining frequency characteristics that more closely match those of the input signal.

### CROSS-REFERENCE TO RELATED APPLICATIONS

This application claims the benefit of the filing dates of U.S. provisional application No. 60/360,855, filed on Mar. 1, 2002, and 60/362,651, filed on Mar. 8, 2002.

### FIELD OF THE INVENTION

The present invention relates to signal processing, and, in particular, to techniques for reducing the peak-to-average power ratio in signals prior to amplification.

### BACKGROUND OF THE INVENTION

In conventional communication systems, amplifiers are used to compensate for signal attenuation as signals propagate through the system. In order to minimize the loss of data contained in such signals, an ideal amplifier is able to provide the same level of amplification to input signals having any input power level over the entire operating range of the amplifier. That is, the amplifier should be able to amplify an input signal having the highest power level in the amplifier's operating range by the same amount as input signals having lower power levels. In general, amplifiers that have to operate over larger ranges of input signal power level having higher peak power levels are more expensive to implement than amplifiers that only need to operate over small ranges of input signal power level having smaller peak power levels.

Many conventional communication systems encode data into signals where the power level of the resulting signals varies over time. In some data-encoding schemes, such as CDMA, multiple signals corresponding to different sets of user data are encoded into the same frequency band as a composite signal, where each encoded user signal in the composite signal is statistically independent of every other encoded user signal. Due to this statistical independence, the instantaneous power level of the composite signal typically stays within a predictable range of an expected average power level. However, this same statistical independence implies that the instantaneous power level of the composite signal can and will exceed the expected average power level with predictable degrees of probability. In theory, the highest possible power level in the composite signal corresponds to the sum of the individual peak power levels of the constituent encoded user signals. While this may occur with relatively small degree of probability, especially for systems with large numbers of users, other combinations of signals with slightly lower power levels will occur with correspondingly greater frequency.

In order to avoid having to implement expensive amplifiers that are capable handling the occurrences of peak power levels in the composite input signals, conventional communication systems clip the input signal prior to amplification in order to reduce the peak-to-average power ratio of the input signal. The clipping is done either intentionally and controlled by a clipping algorithm or unintentionally and controlled de facto by the saturation effects in the amplifier. A typical clipping algorithm involves limiting the instantaneous power level of the input signal to some specified magnitude (i.e., the clip level). In such a scheme, all portions of the input signal having an instantaneous power level less than or equal to the clip level are left unchanged, while those portions of the input signal having an instantaneous power level greater than the clip level are modified such that the instantaneous power level is equal to the clip level.

Since such clipping adds frequency components to the clipped signal outside of the signal band (which can interfere with other signals in the system), conventional communication systems apply a low-pass or band-pass filter to the clipped input signal to remove or at least reduce these extraneous frequency components. Since filtering the entire clipped input signal filters both the unmodified (i.e., unclipped) as well as the modified (i.e., clipped) portions of the input signal, the types of filtering that can be implemented are limited to relatively weak filtering that does not substantially adversely affect the unmodified portions of the input signal.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a high-level block diagram of a system for reducing the peak-to-average power ratio of an input signal, according to one embodiment of the present invention;

FIG. 2 shows a block diagram of a system for reducing the peak-to-average power ratio, according to a particular implementation of the generic system shown in FIG. 1;

FIG. 3 graphically represents the frequency characteristics of an exemplary CDMA composite signal;

FIGS. 4 and 5 show graphs of the power distribution and the spectral density, respectively, for a 12-carrier IS-95/cdmaOne composite signal; and

FIGS. 6 and 7 show graphs of the power distribution and the spectral density, respectively, for the same 12-carrier IS-95/cdmaOne signal as processed according to one possible implementation of the present invention.

### DETAILED DESCRIPTION

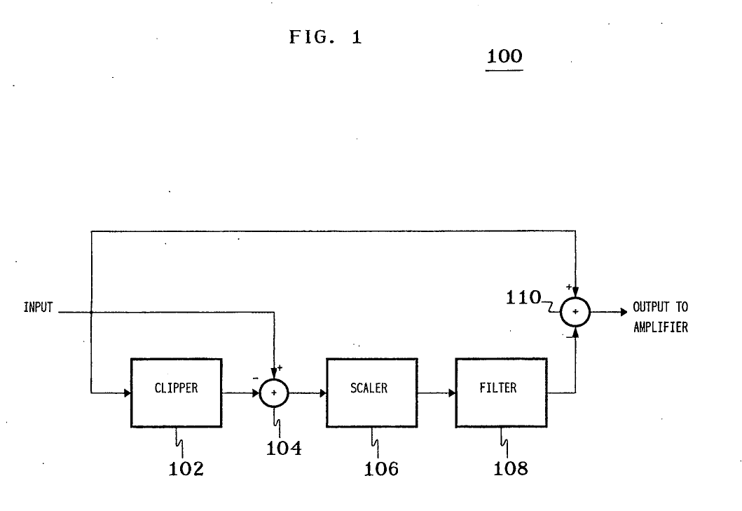

FIG. 1 is a high-level block diagram of a generic system 100 for reducing the peak-to-average power ratio of an input signal, according to certain embodiments of the present invention. According to system 100, an input signal is clipped at clipper 102. The resulting clipped signal is subtracted from the original input signal at summation node 104 to generate an error signal corresponding to only that portion of the input signal that was clipped by clipper 102. The error signal is then (optionally) scaled at scaler 106 and filtered at filter 108 to generate a filtered error signal that is then subtracted from the original input signal at summation node 110 to generate an output signal that corresponds to a version of the input signal having a reduced peak-to-average power ratio. The purpose of scaling is to compensate for loss in power due to filtering or to adjust the magnitude of the filtered error signal to obtain a desired final peak-to-average power ratio subjected to another desired level of system performance. Since scaler 106 and filter 108 both preferably implement linear operations, the scaling operation can alternatively be implemented after the filtering operation. In general, the scaler may be considered to be part of the filter. In a practical implementation, for a single-width frequency band system, the scaling operation is based on a real constant.

Depending on the particular application in which system 100 is implemented, the output signal may then be applied to an amplifier, such as the base station power amplifier of a CDMA wireless communications network. Since the signal applied to the amplifier has a lower peak-to-average power ratio than the original input signal, for a desired level of system performance (e.g., maximum bit-error rate), a less expensive implementation may be used for the amplifier than would be the case if the original input signal were to be amplified.

Moreover, since only the error signal—rather than the entire input signal—is filtered, a wider variety of filtering can be applied by filter 108 without substantially adversely affecting the entire input signal. In particular, for a desired level of system performance, filter 108 is able to be implemented using relatively strong filtering as compared to the prior art filtering.

In particular implementation, the output signal could be fed back to be processed by system 100 one or more times in order to fine-tune the output signal in order to achieve a desired final peak-to-average power ratio subjected to another desired level of system performance.

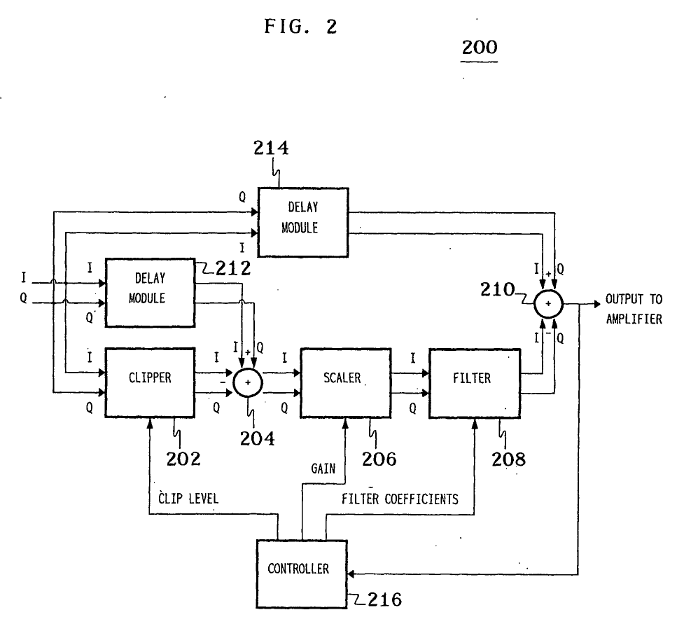

FIG. 2 shows a block diagram of a system 200 for reducing the peak-to-average power ratio, according to a particular implementation of the generic system shown in FIG. 1. In particular, system 200 processes the in-phase (I) and quadrature (Q) components of a typical complex input signal. As shown in FIG. 2, in addition to elements 202-210, which are analogous to elements 102-110 of system 100 of FIG. 1, system 200 is implemented with delay modules 212 and 214, which synchronize the timing of the various signals applied to summation nodes 204 and 210, respectively.

System 200 also has a controller 216 that controls the operations of clipper 202, scaler 206, and filter 208. In particular, controller 216 controls the clip level applied by clipper 202, the gain applied by scaler 206, and the filter coefficients used to implement filter 208, potentially based, at least in part, on using the output signal as feedback indicating the quality of the processing. In some implementations, in addition to adjusting the amplitude of the error signal generated at summation node 204, scaler 206 is able to adjust the phase of the error signal. In that case, controller 216 would also preferably control the phase adjustment applied by scaler 206, which would then apply a complex scaling factor based on both amplitude and phase.

In a preferred implementation, clipper 202 implements circular clipping in which the magnitude of the complex input signal is limited to the specified clip level. In an alternative implementation, each of the I and Q components could be independently limited to the specified clip level.

Although the present invention can be implemented with conventional low-pass or band-pass filters such as those used in the prior art, in preferred embodiments, filter 208 is designed to match the frequency characteristics of the input signal. That is, the frequency response of filter 208 is designed to match the frequencies represented in the composite input signal.

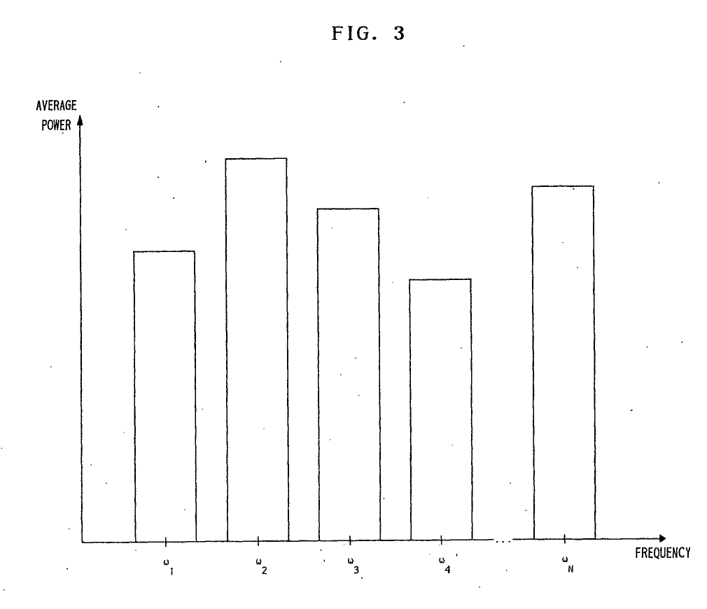

FIG. 3 graphically represents the frequency characteristics of an exemplary CDMA composite signal. As shown in FIG. 3, the composite signal has a number (N) of different frequency bands, each of which is typically made up of one or more user signals. Because the number of users in each frequency band can vary (over time and from band to band), the bands are depicted in FIG. 3 having different average power levels. Note also that all of the frequency bands in the composite signal of FIG. 3 have the same width and are separated by the same inter-band distance. In other applications of the present invention, the composite signal might have other characteristics. For example, the widths of the frequency bands may vary and/or the distances between adjacent bands may differ from band to band.

In a preferred implementation, filter 208 is designed to be equivalent to the sum of N band-pass filters, each corresponding to a different frequency band in the composite signal of FIG. 3. Since each frequency band has the same width, each of the different band-pass filters can be based on a single baseband filter structure F_{A0} that is shifted in frequency based on the center frequency ωᵢ of the corresponding frequency band using standard frequency-domain translation in which the baseband filter is multiplied by the frequency dependent term e^{jω}^{t}. In that case, filter 208 can be represented by the composite filter function F_{A} according to Equation (1) as follows:

F_{A}=F_{A0}(A₁e^{jω}^{₁}^{t}+A₂e^{jω}^{₂}^{t}+A₃e^{jω}^{₃}^{t}+ . . . +A_{N}e^{jω}^{_{N}}^{t}) (1)

where the frequency-domain-translation amplitude-adjustment parameters Aᵢ are preferably complex constants. Note that scaler 206 can be implemented as part of filter 208 by appropriate setting of the amplitude-adjustment parameters Aᵢ.

For filters implemented based on Equation (1), controller 216 would need only provide a single set of filter coefficients to filter 208 corresponding to the implementation of the basic filter F_{A0} as well as the amplitude-adjustment parameters Aᵢ and the center-frequency parameters ωᵢ. In this way, the present invention is able to easily adjust for changes that may occur in the composite signal over time. For example, if the center frequencies of particular frequency bands change over time, then this can be accounted for by simply updating the corresponding center-frequency parameters ωᵢ. Similarly, if particular frequency bands are not present at all times, then this can be accounted for by simply setting the corresponding amplitude-adjustment parameters Aᵢ to zero. Depending on the implementation, the remaining non-zero parameters Aᵢ may be the same or different, real or complex constants.

In applications in which the width of the frequency bands vary from band to band with different filter rejection requirements, the basic filter structure F₀ would preferably be given by Equation (2) as follows:

F₀=A_{A}F_{A}+A_{B}F_{B}+A_{C}F_{C}+ . . . +A_{K}F_{K} (2)

where each individual composite filter function F_{I} is of the form given by Equation (1), one for each specific frequency band of interest identified with the basic filter F_{I0}, and A_{I} are complex adjustable constants.

Experimental Results

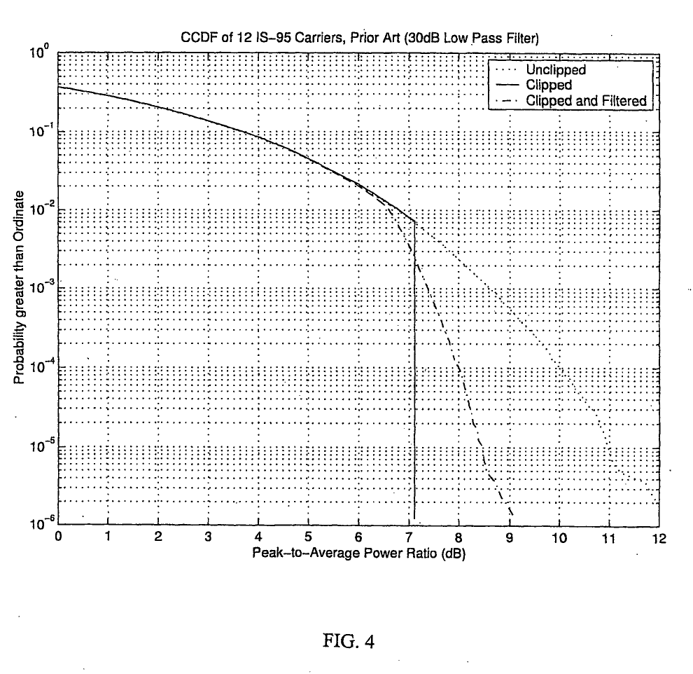

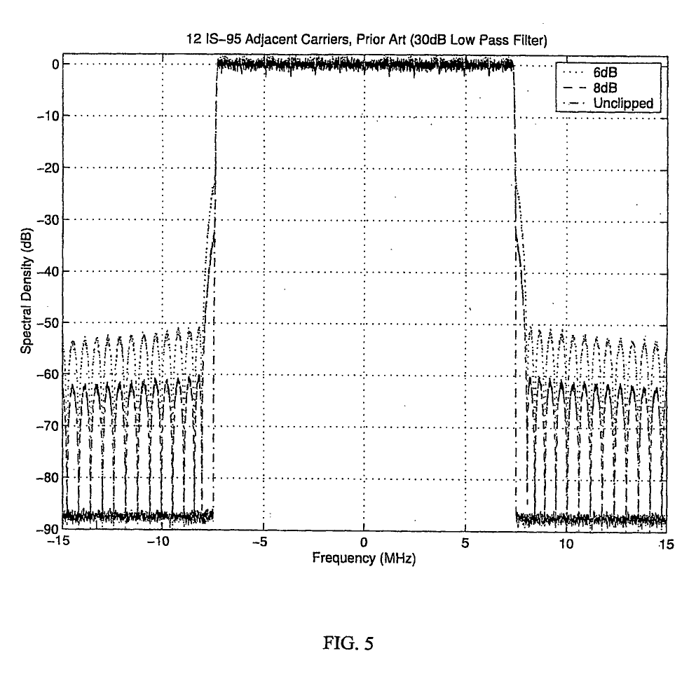

FIGS. 4 and 5 show graphs of the power distribution and the spectral density, respectively, for a 12-carrier IS-95/cdmaOne composite signal. In particular, FIG. 4 shows the probability of a greater instantaneous signal power level as a function of the peak-to-average power ratio (in dB) for the original (i.e., unclipped) composite signal as well as for the original composite signal after it has been circularly clipped at a clipping threshold, followed by the application of a 30-dB low-pass filter to the resulting clipped, composite signal. FIG. 5 shows the spectral density (in dB) vs. frequency (in MHz) for the original, composite signal and the circularly clipped and filtered signals with final peak-to-average power ratios of 6 dB and 8 dB. Note that the non-zero probability of signals greater than the corresponding clip level is associated with peak regrowth that occurs during the filtering process that follows the clipping.

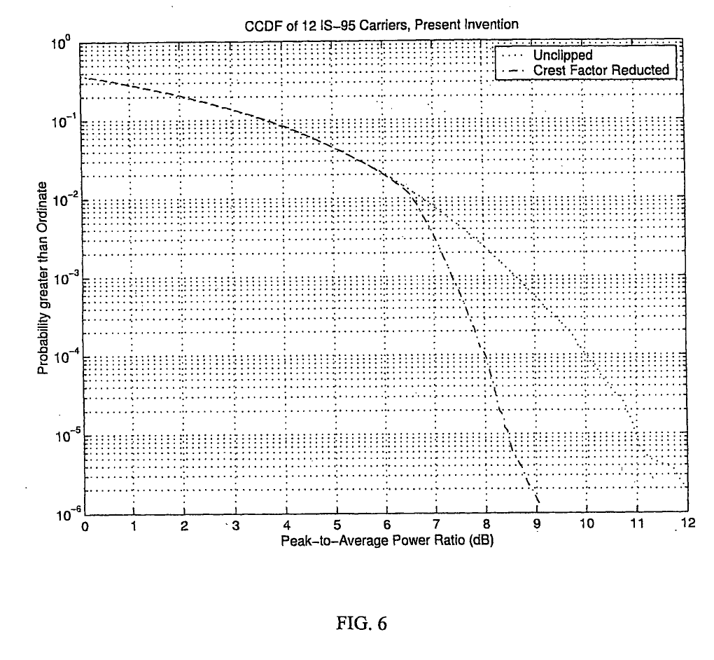

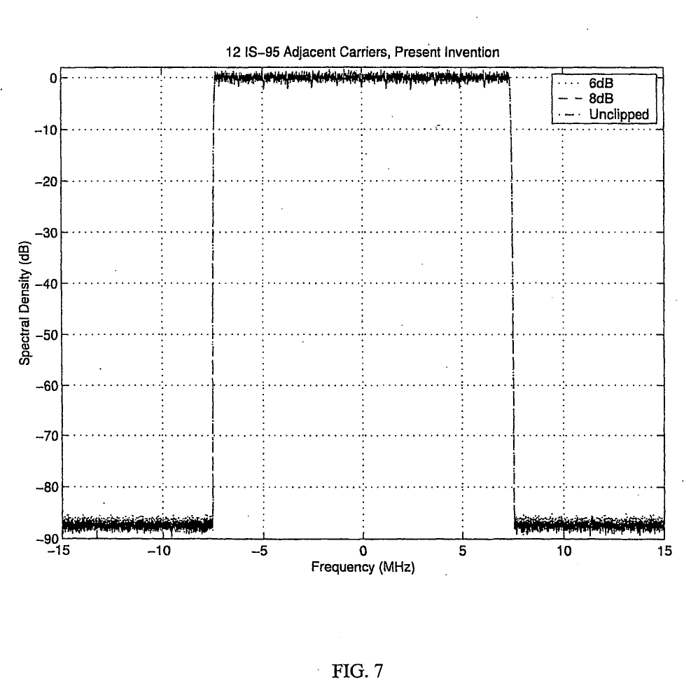

FIGS. 6 and 7 show graphs of the power distribution and the spectral density, respectively, for the same 12-carrier IS-95/cdmaOne signal as processed according to one possible implementation of the present invention. According to this implementation, following circular clipping, the corresponding clipped error signal was filtered using a composite filter formed from using the frequency-shifted version of the original baseband filter at each of the 12 frequency bands in the original composite signal. The frequency characteristics of the composite filter are essentially the same as those of the original composite signal.

As indicated by the results shown in the figures, clipping and filtering in accordance with this implementation to the present invention as shown in FIGS. 6 and 7 provide advantages over the clipping and filtering represented by FIGS. 4 and 5. In particular, comparing FIGS. 4 and 6, the implementation of the present invention, as represented in FIG. 6, has essentially eliminated the peak regrowth evident in FIG. 4. The spectrum of the crest-factor-reduced waveforms are virtually identical to that of the original composite signal.

Furthermore, since, in the implementation of the present invention, the filtering is based on the spectral properties of the frequency bands that form the original composite signal, the resulting filtered, clipped composite signals are substantially as spectrally clean as the original composite signal. This is evident by comparing the side-lobes (i.e., the residual spectral densities at the edges) of the filtered, clipped composite signals in FIGS. 5 and 7.

Moreover, although not evident in the present example, when adjacent frequency bands are separated from each other, using band-pass filters reduces the spectral regrowth between bands.

Alternative Embodiments

Depending on the particular application, the clipping and/or the filtering of the present invention can be implemented in either the analog or the digital domain using input signals that may be baseband, intermediate frequency (IF), or radio frequency (RF) signals to generate output signals that may analog or digital at baseband, IF, or RF. For example, a digital baseband input signal could be processed to generate an analog RF output signal. Depending on the particular application, the implementation would involve appropriate combinations of analog-to-digital (A/D), digital-to-analog (D/A), and frequency (e.g., baseband to IF/RF or IF/RF to baseband) conversion.

The present invention may be implemented in the context of wireless signals transmitted from a base station to one or more mobile units of a wireless communication network. In theory, embodiments of the present invention could be implemented for wireless signals transmitted from a mobile unit to one or more base stations. The present invention can also be implemented in the context of other wireless and even wired communication networks.

Although the present invention has been described in the context of circuitry in which clipping is applied to reduce the peak-to-average power ratio of a signal to be applied to signal handling equipment, where the signal handling equipment is an amplifier, the present invention is not so limited. In general, the present invention may be employed in any suitable circuitry in which a signal is clipped prior to being applied to signal handling equipment, where the signal handling equipment may be other than an amplifier.

Embodiments of the present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

It will be further understood that various changes in the details, materials, and arrangements of the parts which have been described and illustrated in order to explain the nature of this invention may be made by those skilled in the art without departing from the scope of the invention as expressed in the following claims.

1. Apparatus for processing a composite baseband input signal, comprising:
(a) a clipper adapted to clip the composite baseband input signal to generate a clipped signal;
(b) a first summation node adapted to generate an error signal based on a difference between the composite baseband input signal and the clipped signal;
(c) a filter adapted to filter the error signal to generate a filtered error signal wherein:
frequency characteristics of the filter match the frequency characteristics of the composite baseband input signal;
the filter corresponds to a combination of a plurality of band-pass filters:
each band-pass filter corresponds to a different frequency band in the composite baseband input signal; and
the filter is implemented by applying frequency-domain translation to a single baseband filter to form each band-pass filter; and
(d) a second summation node adapted to generate an output signal based on a difference between the composite baseband input signal and the filtered error signal.

2. The invention of claim 1, further comprising a scaler configured either before or after the filter and adapted to generate, in combination with the filter, the filtered error signal as a scaled signal to compensate for power lost in the filter or to adjust magnitude of the filtered error signal to obtain a desired peak-to-average power ratio for the output signal.

3. The invention of claim 1, wherein the output signal is applied to an amplifier.

4. The invention of claim 3, wherein the output signal is processed by the apparatus one or more times before being applied to the amplifier to obtain a desired peak-to-average power ratio for the output signal.

5. The invention of claim 3, wherein the apparatus further comprises the amplifier.

6. The invention of claim 1, wherein the clipper implements circular clipping.

7-9. (canceled)

10. The invention of claim 1, wherein the filter is implemented using a single set of filter coefficients corresponding to the baseband filter.

11. The invention of claim 1, further comprising a delay module corresponding to each summation node and adapted to synchronize signals combined at the corresponding summation node.

12. The invention of claim 1, further comprising a controller adapted to control operations of the clipper, the filter, or both.

13. The invention of claim 12, wherein the controller controls the operations using the output signal as a feedback signal.

14. The invention of claim 1, wherein:
the output signal is applied to an amplifier;
the clipper implements circular clipping;
the filter is implemented using a single set of filter coefficients corresponding to the baseband filter;
further comprising a delay module corresponding to each summation node and adapted to synchronize signals combined at the corresponding summation node; and
further comprising a controller adapted to control operations of the clipper, the filter, or both, wherein the controller controls the operations using the output signal as a feedback signal.

15. The invention of claim 14, further comprising a scaler configured either before or after the filter and adapted to generate, in combination with the filter, the filtered error signal as a scaled signal to compensate for power lost in the filter or to adjust magnitude of the filtered error signal to obtain a desired peak-to-average power ratio for the output signal.

16. The invention of claim 14, wherein the output signal is processed by the apparatus one or more times before being applied to the amplifier to obtain a desired peak-to-average power ratio for the output signal.

17. The invention of claim 14, wherein the apparatus further comprises the amplifier.

18. A method for processing a composite baseband input signal, comprising:
clipping the composite baseband input signal to generate a clipped signal;
generating an error signal based on a difference between the composite baseband input signal and the clipped signal;
filtering the error signal to generate a filtered error signal, wherein:
frequency characteristics of the filtering match the frequency characteristics of the composite baseband input signal:
the filtering corresponds to a combination of a plurality of band-pass filtering;
each band-pass filtering corresponds to a different frequency band in the composite baseband input signal; and
the filtering is implemented by applying frequency-domain translation to a single baseband filter to form each band-pass filtering; and
generating an output signal based on a difference between the composite baseband input signal and the filtered error signal.

19. The invention of claim 18, further comprising scaling to generate, in combination with the filtering, the filtered error signal as a scaled signal to compensate for power lost during the filtering or to adjust magnitude of the filtered error signal to obtain a desired peak-to-average power ratio for the output signal.

20. The invention of claim 18, further comprising applying the output signal to an amplifier.

21. The invention of claim 20, wherein the output signal is processed by the method one or more times before being applied to the amplifier to obtain a desired peak-to-average power ratio for the output signal.

22. The invention of claim 18, wherein the clipping is circular clipping.

23-25. (canceled)

26. The invention of claim 18, wherein the filtering is implemented using a single set of filter coefficients corresponding to the baseband filter.

27. The invention of claim 18, further comprising delaying the composite baseband input signal to synchronize the signals combined during generation of the error signal and during generation of the output signal.

28. The invention of claim 18, further comprising controlling operations of the clipping, the filtering, or both.

29. The invention of claim 28, wherein controlling the operations uses the output signal as a feedback signal.

30. The invention of claim 18, wherein:
the output signal is applied to an amplifier;
the clipping is circular clipping;
the filtering is implemented using a single set of filter coefficients corresponding to the baseband filter;
further comprising delaying the composite baseband input signal to synchronize the signals combined during generation of the error signal and during generation of the output signal; and
further comprising controlling operations of the clipping, the filtering, or both, wherein controlling the operations using the output signal as a feedback signal.

31. The invention of claim 30, further comprising scaling to generate, in combination with the filtering, the filtered error signal as a scaled signal to compensate for power lost during the filtering or to adjust magnitude of the filtered error signal to obtain a desired peak-to-average power ratio for the output signal.

32. The invention of claim 30, wherein the output signal is processed by the method one or more times before being applied to the amplifier to obtain a desired peak-to-average power ratio for the output signal.
